(19) United States
(12) Patent Application Publication
(10) Pub. No.: US 2019/0026703 A1
(43) Pub. Date: Jan. 24, 2019

(54) INFORMATION TRANSMISSION METHOD, RECORDING MEDIUM STORING INFORMATION TRANSMISSION PROGRAM, AND INFORMATION PROCESSING APPARATUS

(71) Applicant: FUJITSU LIMITED, Kawasaki-shi (JP)

(72) Inventors: Xin Wang, Ota (JP); Masahiro USUI, Yokohama (JP); HIROKO YUKI, Yokohama (JP)

(73) Assignee: FUJITSU LIMITED, Kawasaki-shi (JP)

(21) Appl. No.: 16/137,599

(22) Filed: Sep. 21, 2018

Related U.S. Application Data
(63) Continuation of application No. PCT/JP2016/059986, filed on Mar. 28, 2016.

(51) Int. Cl. G06Q 20/04; G06Q 20/38

(52) U.S. Cl. CPC G06Q 20/045; G06Q 20/389

(57) ABSTRACT

An information transmission method includes: detecting, by a computer, that at least part of a cash voucher associated with electronic information is used, identifying a first user who sets a right of the cash voucher associated with the electronic information to a second user, acquiring, when detecting creation or transmission of a message addressed to a first address used by the first user from a second address used by the second user, a use history of the cash voucher associated with the electronic information; and transmitting the acquired use history together with the message.

### CROSS-REFERENCE TO RELATED APPLICATION

This application is a continuation application of International Application PCT/JP2016/059986 filed on Mar. 28, 2016 and designated the U.S., the entire contents of which are incorporated herein by reference.

### FIELD

The embodiments discussed herein are related to an information transmission method, a recording medium storing an information transmission program, and an information transmission system.

### BACKGROUND

A person who gave a cash voucher is notified that the cash voucher has been used.

A related technique is disclosed in Japanese Laid-open Patent Publication No. 2012-221130.

### SUMMARY

According to an aspect of the embodiment, an information transmission method includes: detecting, by a computer, that at least part of a cash voucher associated with electronic information is used, identifying a first user who sets a right of the cash voucher associated with the electronic information to a second user, acquiring, when detecting creation or transmission of a message addressed to a first address used by the first user from a second address used by the second user, a use history of the cash voucher associated with the electronic information; and transmitting the acquired use history together with the message.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a schematic configuration of a system according to Example 1;

FIG. 2 is a diagram illustrating an example of a data configuration of cash voucher information;

FIG. 3 is a diagram illustrating an example of a data configuration of settlement information;

FIG. 4 is a diagram illustrating a schematic configuration of a user terminal according to Example 1;

FIG. 5 is a diagram illustrating an example of a message reception screen;

FIG. 6 is a diagram illustrating an example of a message transmission confirmation screen;

FIG. 7 is a diagram illustrating a sequence of processing of a system according to Example 1;

FIG. 8 is a diagram illustrating a sequence of processing of the system according to Example 2; and

FIG. 9 is a diagram illustrating a computer that executes an information transmission program.

### DESCRIPTION OF EMBODIMENTS

For example, in what form a cash voucher is used, that is, whether payment is made with a cash voucher alone or in combination with money or a credit card depends on the arbitrary behavior of a user using the cash voucher.

For example, only in a case where a cash voucher is used in a specific form, it is notified that the cash voucher has been used to a person who gave the cash voucher. In addition, for example, the person who gave a cash voucher may not be able to know what the cash voucher was used for, that is, what was given through the cash voucher.

For example, a technique may be provided for notifying a person who gives a cash voucher of the use history of the cash voucher.

Examples of an information transmission method, an information transmission program, an information transmission system, a mail transmission control method, a mail transmission control program, and a terminal according to the present embodiment will be described in detail below with reference to drawings. The present embodiment is not limited by these examples. It is possible to combine each of the examples appropriately as long as the processing details do not conflict.

### EXAMPLE 1

System Configuration

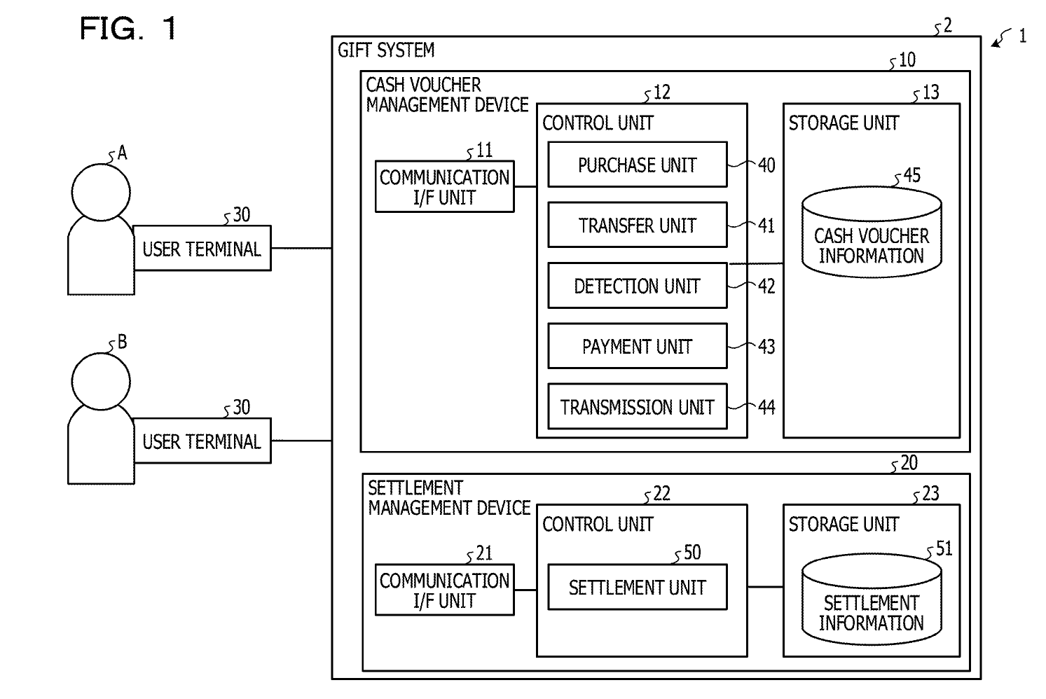

First, an example of a system 1 according to Example 1 will be described. FIG. 1 is a diagram illustrating an example of a schematic configuration of the system according to Example 1. The system 1 is a system that provides users with services relating to cash vouchers and settlement. In this example, for example, the case where a system 1 provides a user with services relating to sales of cash vouchers, transfer of cash vouchers, management of cash vouchers, settlement for used cash vouchers, settlement for unused cash vouchers, message transmission, and the like will be described. The cash voucher in the present example is a cash voucher correlated with electronic information. The cash voucher may be, for example, data identified by a code represented by a character string. In addition, for example, the cash voucher may be a paper on which a QR code (registered trademark) or the like for specifying information of the cash voucher is printed.

As illustrated in FIG. 1, the system 1 includes a gift system 2 and a user terminal 30. The user terminal 30 of the system 1 and the gift system 2 are communicably connected via a network. As one aspect of such a network, any type of communication networks such as a local area network (LAN) or a virtual private network (VPN) may be adopted regardless of wired or wireless. In the example of FIG. 1, the case where two users are a user A and a user B and the two user terminals 30 are provided has been illustrated, but the present embodiment is not limited thereto and the number of users and user terminals 30 may be random.

The gift system 2 is a computer or a computer system that provides the users with a cash voucher management service and a settlement service. The gift system 2 may be implemented as a single computer or may be implemented by a plurality of computers. In the present example, the case where the gift system 2 is implemented as two computers, that is, the cash voucher management device 10 and the settlement management device 20 will be described as an example. The cash voucher management device 10 is an example of an information transmission system.

The user terminal 30 is a device possessed by the user who receives a service from the gift system 2. For example, the user terminal 30 is a portable terminal device such as a smartphone or a tablet terminal. In addition, the user terminal 30 may be a computer such as a notebook computer or a personal computer. In addition, the user receives a service provided by each server via, for example, an application provided in the user terminal 30.

The cash voucher management device 10 provides a cash voucher service to the user. The cash voucher management device 10 includes a communication interface (I/F) unit 11, a control unit 12, and a storage unit 13. The communication I/F unit 11 is an interface for performing communication control with other devices. The communication I/F unit 11 transmits and receives various kinds of information to and from other devices via a network. As the communication I/F unit 11, a network interface card such as a LAN card may be adopted. The control unit 12 includes a purchase unit 40, a transfer unit 41, a detection unit 42, a payment unit 43, and a transmission unit 44.

The storage unit 13 is a storage device such as a hard disk, a solid-state drive (SSD), an optical disk, or the like. The storage unit 13 may be a semiconductor memory in which data may be rewritten, such as random-access memory (RAM), flash memory, non-volatile static random-access memory (NVSRAM), or the like. In addition, the storage unit 13 may be a server device that stores and provides data.

The storage unit 13 stores various programs. In addition, the storage unit 13 stores various data used in the various programs. For example, the storage unit 13 stores cash voucher information 45.

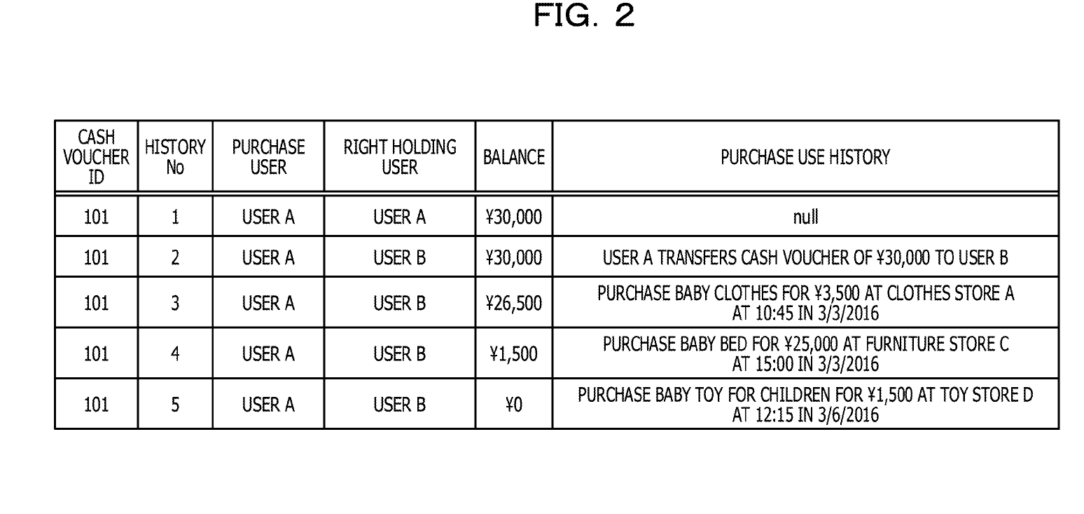

The cash voucher information 45 is data storing information on cash voucher data. For example, in the cash voucher information 45, a purchased user of cash voucher data, a balance, and the like are stored. FIG. 2 is a diagram illustrating an example of a data configuration of cash voucher information. As illustrated in FIG. 2, the cash voucher information 45 has items such as “cash voucher ID”, “history No.”, “purchase user”, “right holding user”, “balance,” “purchase use history”, and the like. Each item of the cash voucher information 45 illustrated in FIG. 2 is an example, and other items may be included.

The item of cash voucher ID is an area for storing an ID for identifying cash voucher data. In the item of cash voucher ID, a cash voucher ID for each cash voucher data set at the time of purchasing a cash voucher is stored. The item of history No. is an area for storing a sequence number of a history of the processing of the cash voucher data. The item of purchase user is an area for storing the user who purchases cash voucher data. The item of right holding user is an area for storing the user having the right to use the cash voucher data. The item of balance is an area for storing the balance of the cash voucher data. The item of purchase use history is an item in which a history such as purchase or use of the cash voucher data is stored. In the item of purchase use history, information on purchase, transfer, use, and the like of the cash voucher data is stored.

The purchase unit 40 performs processing of purchasing a cash voucher in a case where there is a purchase request for a cash voucher from the user and it is detected that there is a deposit from the user. In the processing of purchasing a cash voucher, the purchase unit 40 issues a cash voucher ID, and registers the user who requested purchase of a cash voucher, the amount of the purchase request, and the like in the cash voucher information 45.

For example, as illustrated in the record of history No. “1” in FIG. 2, in a case where a purchase request of the cash voucher ¥30,000 is made from the user A, the purchase unit 40 issues a cash voucher ID “101”, sets the purchase user and the right holding user as “user A”, and registers a balance “¥30,000”.

The transfer unit 41 performs processing of transfer a cash voucher in a case where the user requests to transfer a cash voucher. In the processing of transferring a cash voucher, the transfer unit 41 changes the right holding user from a user who transfers the cash vouch to a user to whom the cash voucher is transferred.

For example, as illustrated in the record of history No. “2” in FIG. 2, in a case where a transfer request of a cash voucher with cash voucher ID “101” is made from the user A to the user B, the transfer unit 41 changes the right holding user from “user A” to “user B”. In the example of FIG. 2, the transfer unit 41 leaves the record of history No. “1” and adds the record of history No. “2”, but the transfer unit 41 may delete the record of history No. “1” and add the record of history No. “2” or may change the right holding user of the record of history No. “1” to “user B” without adding a record. In addition, the transfer unit 41 registers a description that the transfer of the cash voucher has been made, together with the date and time when the transfer is made, in the purchase use history.

The detection unit 42 detects that at least a part of the cash voucher has been used. The detection unit 42 may detect the use of the cash voucher by periodically obtaining information from the settlement management device 20 by API or the like. In addition, when settlement is performed for the used cash voucher, the settlement management device 20 may transmit information on the settlement to the detection unit 42. For example, the detection unit 42 detects that the cash voucher has been used for the first time after purchase or transfer. Further, for example, the detection unit 42 detects that a full amount of the cash voucher has been used after purchase or transfer, that is, the balance has become 0.

The payment unit 43 performs processing of settlement when it is detected by the detection unit 42 that the payment has been performed for the used cash voucher. In the processing of payment, the payment unit 43 deducts from the balance of the used cash voucher and registers the purchase use history.

For example, as illustrated in the record of history No. “3” in FIG. 2, in a case where it is detected by the detection unit 42 that baby clothes have been bought for ¥3,500 by using a cash voucher at a clothes store A, the payment unit 43 deducts ¥3,500 from the balance, which leaves the balance to be ¥26,500. As in the case of the transfer unit 41, the payment unit 43 may or may not add a record. In addition, the payment unit 43 registers the information of purchase stores, purchased articles or the like in which the cash voucher was used, together with the date and time of the use, in the purchase use history.

The transmission unit 44 transmits a message or the like to the user terminal 30. When the use of the cash voucher is detected by the detection unit 42, first, the transmission unit 44 specifies a first user who set the use right of the cash voucher as a second user. Then, in the case of detecting creation or transmission of a message addressed to a first address used by the first user from a second address used by the second user, the transmission unit 44 acquires the use history of the cash voucher, adds the acquired use history to the message, and transmits the acquired use history.

For example, in a case where the detection unit 42 detects the use of the cash voucher illustrated in the record of the history No. “3” in FIG. 2, first, the transmission unit 44 specifies the user A who set the use right of the cash voucher to the user B. Then, for example, in the case of detecting creation or transmission of a message addressed to the mail address of the user A from the mail address of the user B, the transmission unit 44 acquires the use history of the cash voucher from the cash voucher information 45, adds the acquired use history to the message, and transmits the message.

In addition, in a case where the use of the cash voucher is detected by the detection unit 42, the transmission unit 44 may display a confirmation screen asking whether or not to transmit a message addressed to the address of the first user on the screen of the terminal used by the second user. In this case, in the case of receiving an input indicating that the message is to be transmitted from the terminal used by the second user, the transmission unit 44 acquires the use history of the cash voucher. Then, the transmission unit 44 transmits the acquired use history together with a message addressed to the address of the first user received from the terminal used by the second user.

For example, in a case where the detection unit 42 detects the use of the cash voucher illustrated in the record of history No. “3” in FIG. 2, first, the transmission unit 44 may display a confirmation screen asking whether or not to transmit a message addressed to the address of the user A on the screen of the user terminal 30 of the user B. In this case, in the case of receiving an input indicating that the message is to be transmitted from the user terminal 30 of the user B, the transmission unit 44 acquires the use history of the cash voucher from the cash voucher information 45. Then, the transmission unit 44 transmits the acquired use history together with the message addressed to the address of the user A received from the user terminal 30 of the user B.

In addition, for example, the transmission unit 44 transmits a use statement including a used amount of the cash voucher and information on products purchased or names or a picture of products purchased by the cash voucher as a use history.

It is conceivable that using the cash voucher is further detected by the detection unit 42 after the transmission unit 44 transmits the use history. In this case, in the case of receiving a signal indicating that the use history is allowed to be added from the user terminal 30 of the user B, the transmission unit 44 may add the use history together with a message and transmit the use history to the user terminal 30 of the user A.

The settlement management device 20 provides a payment service to the user. The settlement management device 20 includes a communication I/F unit 21, a control unit 22, and a storage unit 23. The communication I/F unit 21 is an interface for performing communication control with other devices. The communication I/F unit 21 exchanges various information with other devices via a network. As the communication I/F unit 21, a network interface card such as a LAN card may be adopted. The control unit 22 includes a settlement unit 50.

The storage unit 23 is a storage device such as a hard disk, an SSD, an optical disk, or the like. The storage unit 23 may be a semiconductor memory in which data may be rewritten, such as RAM, flash memory, NVSRAM or the like. In addition, the storage unit 23 may be a server device that stores and provides data.

The storage unit 23 stores various programs. In addition, the storage unit 23 stores various data used in the various programs. For example, the storage unit 23 stores settlement information 51.

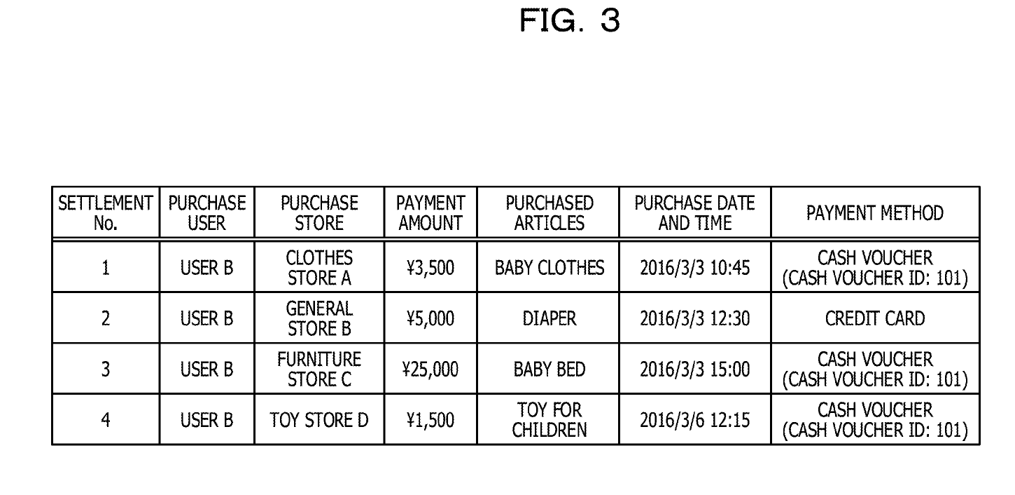

The settlement information 51 is data in which information on settlement is stored. For example, in the settlement information 51, the store where the settlement has been performed, the settlement amount, and the like are stored. FIG. 3 is a diagram illustrating an example of a data configuration of settlement information. As illustrated in FIG. 3, the settlement information 51 includes items such as “settlement No.”, “purchase user”, “purchase store”, “settlement amount”, “purchased articles”, “purchase date and time”, “payment method”, and the like. Each item of the settlement information 51 illustrated in FIG. 3 is an example, and other items may be included.

The item of settlement No is an area for storing a serial number of a settlement history. The item of purchase user is an area for storing the user who settled. The item of purchase store is an area for storing the store where settlement is made. The item of the purchased item is an area for storing the item purchased by settlement. The item of the purchase date and time is an area for storing the date and time when settlement is made. The item of the payment method is an area for storing the kind of payment method which settlement is made by.

The settlement unit 50 performs processing of settlement in a case where the user performs settlement, that is, in a case where a settlement request is made from the user. In the processing of settlement, the settlement unit 50 updates the data stored in the settlement information 51. The settlement unit 50 performs processing of the settlement for the used cash voucher issued at least by the cash voucher management device 10. The settlement unit 50 may or may not perform processing of settlement for the unused cash voucher issued by the cash voucher management device 10.

For example, as illustrated in the record of settlement No. “1” in FIG. 3, when the user B purchases baby clothes for ¥3,500 at the clothes store A by using a cash voucher at 10:45 in Mar. 3, 2016, the settlement unit 50 registers data with the settlement amount as ¥3,500, purchased article as “baby clothes”, purchase date and time as “Mar. 3, 2016, 10:45”, and payment method as “cash voucher (cash voucher ID: 101)”.

In addition, as illustrated in the record of settlement No. “2” in FIG. 3, when the user B purchases diapers for ¥5,000 with a credit card without using a cash voucher at a general shop B at 12:30, in Mar. 3, 2016, the settlement unit 50 registers data with settlement amount as ¥5,000, purchased articles as “diaper”, purchase date and time as “Mar. 3, 2016, 12:30”, and payment method as “credit card”.

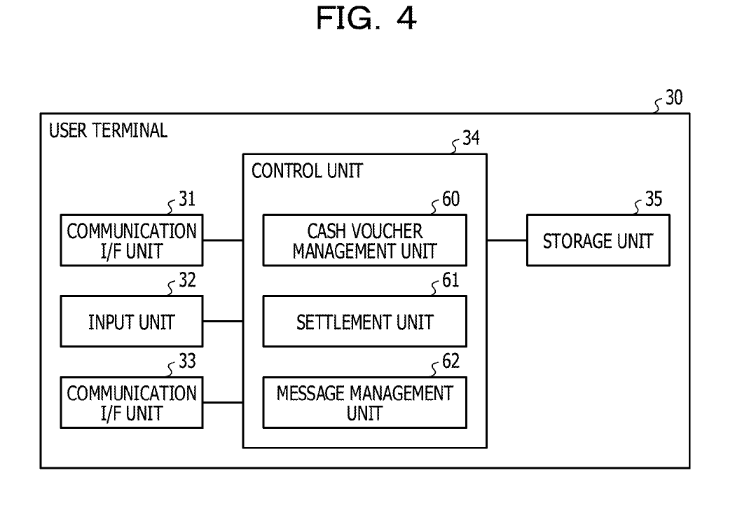

Here, the configuration of the user terminal 30 will be described. FIG. 4 is a diagram illustrating a schematic configuration of a user terminal according to Example 1. The user terminal 30 includes a communication I/F unit 31, an input unit 32, a display unit 33, a control unit 34, and a storage unit 35. The communication I/F unit 31 is an interface for performing communication control with other devices. The communication I/F unit 31 exchanges various information with other devices via a network. As the communication I/F unit 31, a network interface card such as a LAN card may be adopted. The control unit 34 includes a cash voucher management unit 60, a settlement unit 61, and a message management unit 62.

The storage unit 35 is a storage device such as a hard disk, an SSD, an optical disk, or the like. The storage unit 35 may be a semiconductor memory in which data may be rewritten, such as RAM, flash memory, NVSRAM or the like. The storage unit 35 stores various programs. In addition, the storage unit 35 stores various data used in the various programs.

The cash voucher management unit 60 requests purchase or transfer of a cash voucher to the cash voucher management device 10. For example, in a case of requesting purchase of a cash voucher, the cash voucher management unit 60 transmits the information on the user who purchases the cash voucher, the amount of the cash voucher to purchase, and the like to the cash voucher management device 10. In addition, in the case of requesting transfer of a cash voucher, the cash voucher management unit 60 transmits to the cash voucher management device 10 information on the user who transfers the cash voucher, information on the user to whom the cash voucher is transferred, the amount of the cash voucher to be transferred, and the like.

The settlement unit 61 makes a settlement request to the settlement management device 20. For example, when the user performs settlement, the settlement unit 61 transmits information on payment, that is, information on the user's account, credit card, cash voucher or the like to the settlement management device 20. In addition, at this time, the settlement unit 61 transmits the information on the purchase stores and the purchased goods to the settlement management device 20.

The message management unit 62 transmits and receives and displays messages. The message management unit 62 may be a mailer or an application dedicated to the cash voucher service or the like.

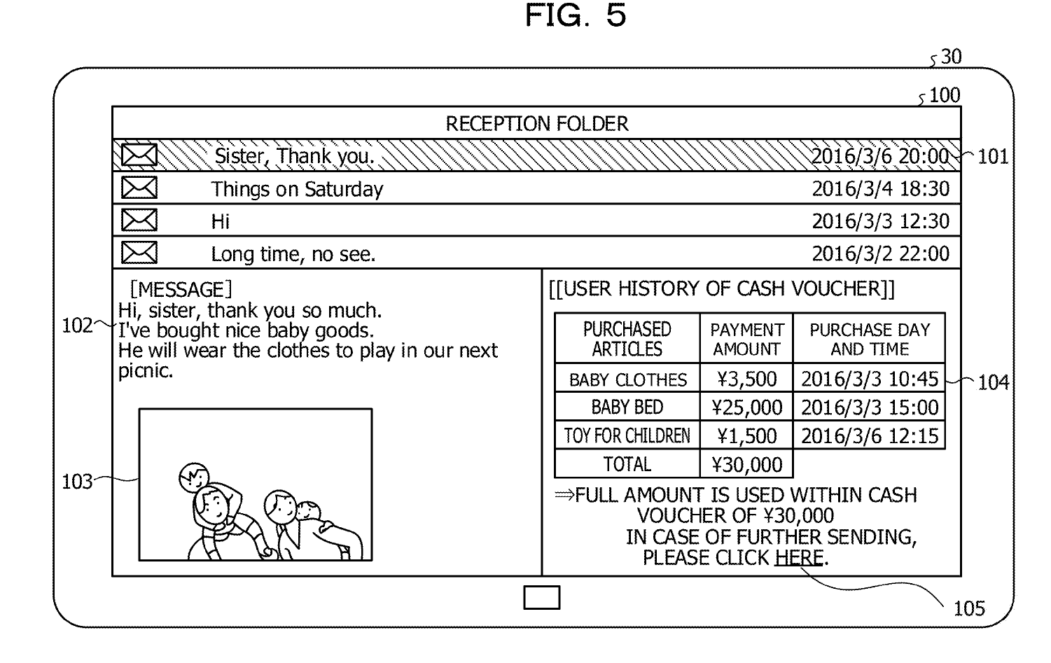

The message management unit 62 displays the use history of the message and the cash voucher transmitted by the transmission unit 44 of the cash voucher management device 10. FIG. 5 is a diagram illustrating an example of a message reception screen. As illustrated in FIG. 5, a message reception screen 100 displayed on the user terminal 30 of the user who transferred the cash voucher has a selection message display area 101 for displaying the title and received date and time of the selected message in a message list. In addition, the message reception screen 100 has a message display area 102 for displaying a message and an attached file display area 103 for displaying a file attached to the message. In addition, the message reception screen 100 has a cash voucher use history display area 104 for displaying the use history of a cash voucher and a cash voucher information display area 105 for displaying guidance on a cash voucher and the like.

FIG. 5 is an example of a screen displayed on the terminal used by an elder sister in a case where a cash voucher purchased by the elder sister is transferred to her younger sister as a baby gift, the younger sister uses the transferred cash voucher, and then, sends a message of thanks to her elder sister. In the example of FIG. 5, as illustrated in the selection message display area 101, a message whose title is “Sister, Thank you.” is selected. Then, in the message display area 102, a message indicating that baby goods have been purchased by using the cash voucher and the message of thanks is illustrated. In addition, in the attached file display area 103, a family picture attached to the message is displayed.

In addition, in the cash voucher use history display area 104, the use details of the transferred cash voucher and the total amount of the used cash voucher are displayed. In addition, in the cash voucher information display area 105, a link for executing processing of requesting additional purchase or transfer of a cash voucher together with a message that the full amount of the cash voucher has been used is displayed.

The link displayed as “here” in the cash voucher information display area 105 is an example of the operation unit. For example, in a case where the user A clicks “here” in the cash voucher information display area 105, the cash voucher management unit 60 is activated and may purchase or transfer a cash voucher. Then, the user A increases the amount of the cash voucher whose right of use belongs to the user B by purchase or transfer.

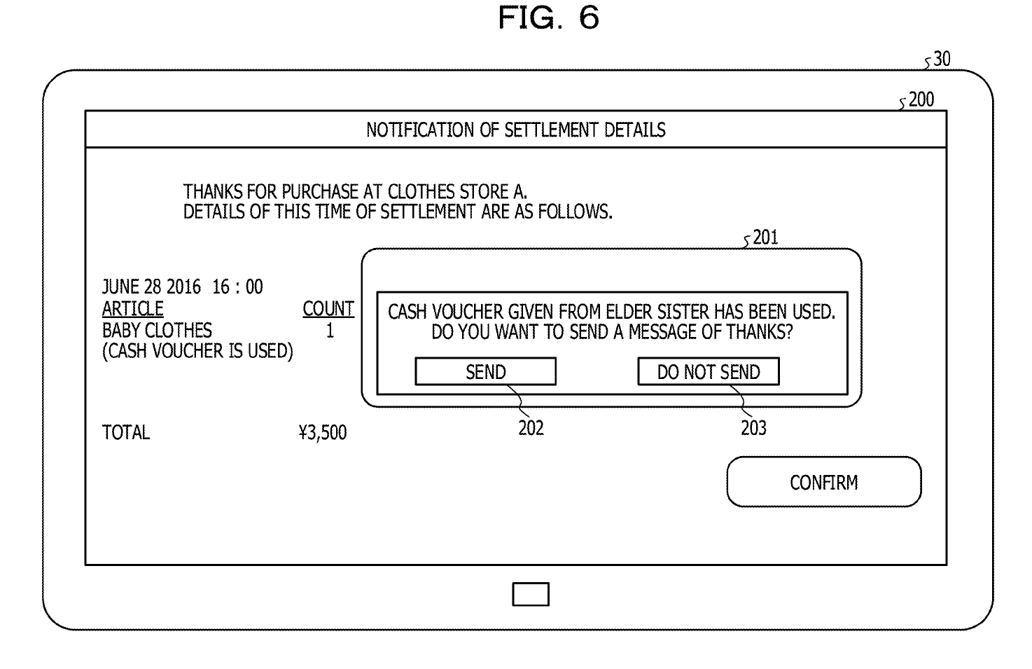

In addition, the message management unit 62 displays a confirmation screen asking whether or not to transmit a message, of which display is controlled by the transmission unit 44 of the cash voucher management device 10. FIG. 6 is a diagram illustrating an example of a message transmission confirmation screen. After the settlement processing is performed by the settlement management device 20, a settlement details notification screen 200 is displayed on the user terminal 30 of the user to whom the cash voucher has been transferred, that is, the user who has used the cash voucher. At this time, a message transmission confirmation screen 201 pops up as a dialog box on the settlement details notification screen 200. The settlement details notification screen 200 displays a message asking whether or not to transmit a message and also displays a send button 202 and a cancel button 203.

In a case where the send button 202 is pressed, the message management unit 62 requests the cash voucher management device 10 to transmit a message. In addition, in a case where the cancel button 203 is pressed, the message management unit 62 does not transmit a message to the cash voucher management device 10 and closes the message transmission confirmation screen 201.

Process Flow

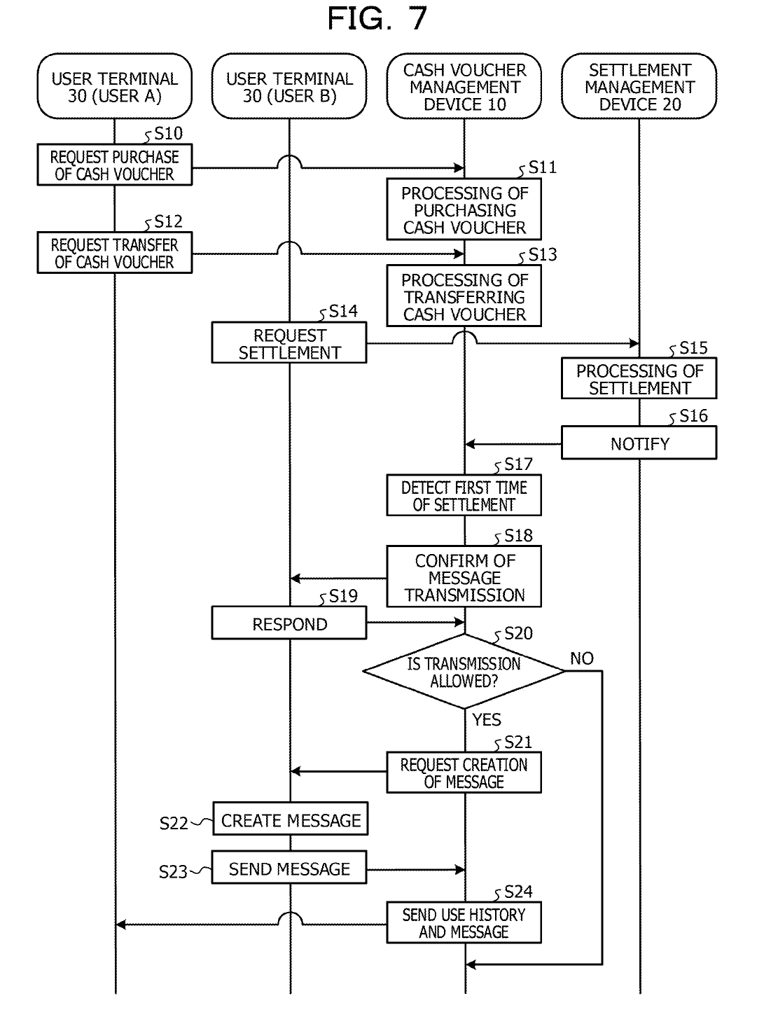

Next, the processing flow of the system 1 according to the present example will be described. FIG. 7 is a diagram illustrating a sequence of processing of the system according to Example 1. As illustrated in FIG. 7, the cash voucher management unit 60 of the user terminal 30 of the user A requests purchase of a cash voucher to the cash voucher management device 10 by operation of the user A (S10). Next, the purchase unit 40 of the cash voucher management device 10 performs processing of purchasing a cash voucher by setting the user A as a right holding user (S11).

Then, the cash voucher management unit 60 of the user terminal 30 of the user A requests the transfer of the cash voucher to the cash voucher management device 10 by operation of the user A (S12). Next, the transfer unit 41 of the cash voucher management device 10 performs processing of transferring the cash voucher by changing the right holding user of the cash voucher from the user A to the user B (S13).

Then, the settlement unit 50 of the user terminal 30 of the user B requests settlement for the used cash voucher to the settlement management device 20 by operation of the user B (S14). Next, the settlement unit 50 of the settlement management device 20 performs settlement processing (S15). Here, the settlement management device 20 notifies the cash voucher management device 10 that the settlement for the used cash voucher has been performed (S16). Then, the detection unit 42 of the cash voucher management device 10 detects settlement for the first time at which settlement for the used cash voucher is performed (S17). At this time, the payment unit 43 performs processing of payment.

Next, the transmission unit 44 confirms whether or not a message is to be transmitted to the user terminal 30 of user B (S18). Then, in a case where the user B permits transmission of the message (S19 and S20: Yes), the transmission unit 44 requests the user terminal 30 to create a message (S21). In addition, in a case where the user B does not permit transmission of the message (S19 and S20, NO), the system 1 ends the processing.

Next, the user terminal 30 of the user B creates a message by an operation of the user B (S22) and transmits the created message to the transmission unit 44 of the cash voucher management device 10 (S23). Then, the transmission unit 44 transmits the message together with the usage history of the cash voucher to the user terminal 30 of the user A (S24).

In addition, the processing of S17 to S23 may not be executed. In this case, when the settlement for the used cash voucher is detected, the cash voucher management device 10 does not confirm whether or not a message is to be transmitted to the user B or does not perform creation of a message. In this case, the cash voucher management device 10 transmits, for example, a preset message such as a fixed form of sentence to the user terminal 30 of the user A together with the use history of the cash voucher.

Effect

The cash voucher management device 10 according to the present embodiment detects that at least part of the cash voucher associated with electronic information has been used. The cash voucher management device 10 identifies the first user who set the right of the cash voucher associated with the electronic information to the second user. The cash voucher management device 10 detects creation or transmission of a message addressed to the first address used by the first user from the second address used by the second user. In the case of detecting the creation or transmission of the message, the cash voucher management device 10 acquires the use history of the cash voucher associated with the electronic information, adds the use history to the message, and transmits the use history. In this way, it is possible to notify the first user, that is, the person who gave the cash voucher, of the use history of the cash voucher. By notifying the use history, it is possible to notify a person who gave the cash voucher of what was given through the cash voucher to a person to whom the cash voucher is given.

In addition, the cash voucher management device 10 detects that at least part of the cash voucher associated with electronic information has been used. The cash voucher management device 10 identifies the first user who set the right of the cash voucher associated with the electronic information to the second user. The cash voucher management device 10 displays a confirmation screen asking whether or not to transmit a message addressed to the address of the first user on the screen of the terminal used by the second user. In the case of receiving an input indicating that the message is to be transmitted from the terminal, the cash voucher management device 10 acquires the use history of the cash voucher associated with the electronic information and also transmits the use history together with the message addressed to the address of the first user received from the terminal.

In this way, it is possible to notify the first user, that is, the person who gave the cash voucher of what was given through the cash voucher. In addition, the second user may arbitrarily decide whether or not to notify the first user of the message and the use history of the cash voucher.

In addition, the detection unit 42 of the cash voucher management device 10 may detect that the cash voucher has been used for the first time after purchase or transfer. In this way, it is possible to notify the first user that the cash voucher has actually started to be used.

In addition, the cash voucher management device 10 may transmit a use statement including a used amount of the cash voucher and information on products purchased or names or a picture of products purchased by the cash voucher as a use history. In this way, the information to be transmitted as the use history may be determined by user setting or the like.

In the case of further detecting the use of the cash voucher after the use history is sent and receiving a signal indicating that the use history is allowed to be added from the terminal used by the second user, the cash voucher management device 10 may add the use history together with the message and transmit the use history to the terminal used by the first user. In this way, the second user may arbitrarily decide whether or not to send the use history additionally.

In order for the cash voucher management device 10 according to the present embodiment to exhibit the above effect, the cash voucher management device 10 may not include all the constituent elements illustrated in FIG. 1. For example, the cash voucher management device 10 may include at least the detection unit 42 and the transmission unit 44. In this case, for example, the purchase unit 40, the transfer unit 41, the payment unit 43, the storage unit 13 are provided in another device connected to the cash voucher management device 10.

### EXAMPLE 2

Although the example relating to the device disclosed so far has been described, the disclosed technique may be implemented in various different forms in addition to the example described above. Therefore, another example included in the present embodiment will be described below.

For example, in the above-described example, the case where the detection unit 42 of the cash voucher management device 10 detects that the cash voucher is used for the first time after purchase or transfer is described, but the detection unit 42 may detect that the full amount of the cash voucher has been used.

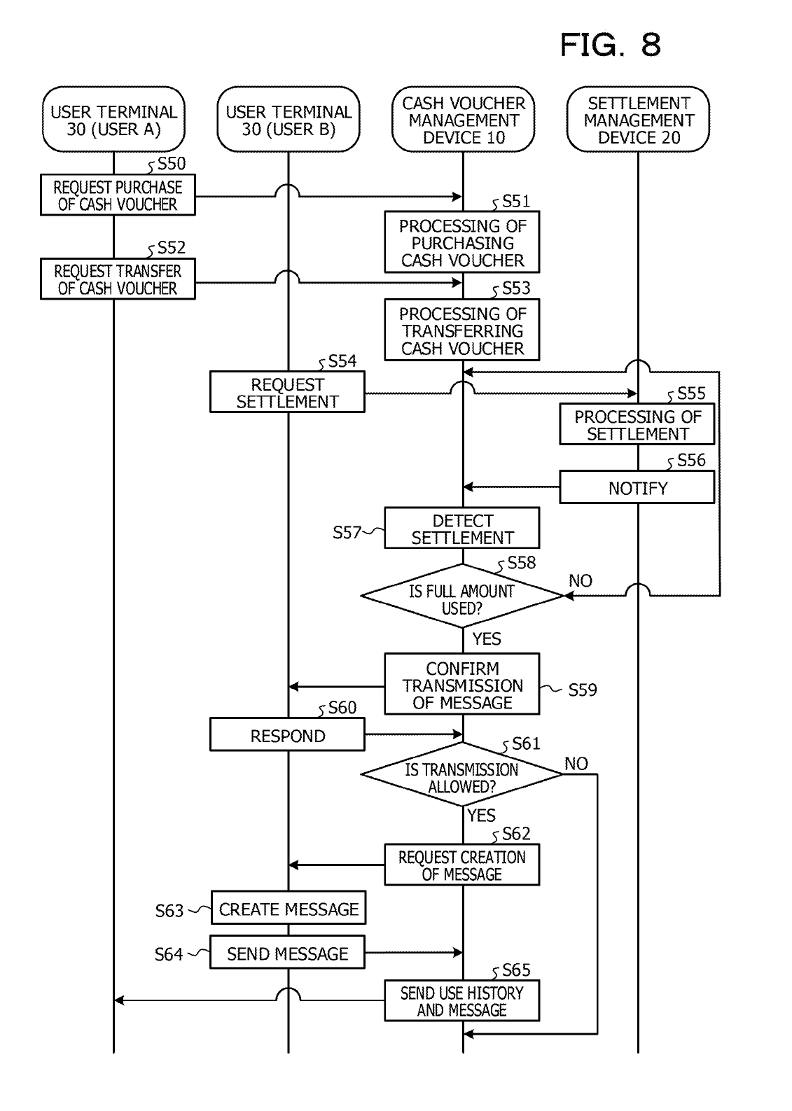

FIG. 8 is a diagram illustrating a sequence of processing of the system according to Example 2. The processing from S50 to S56 in FIG. 8 is the same as the processing from S10 to S16 in FIG. 7, and the description is omitted. Then, when the settlement management device 20 notifies the cash voucher management device 10 that settlement has been performed for the used cash voucher, the detection unit 42 of the cash voucher management device 10 detects that the settlement for the used cash voucher has been performed (S57).

Here, in a case where the full amount of the cash voucher is not used by the settlement detected by the detection unit 42 and the balance remains (S58: No), the cash voucher management device 10 waits until the next settlement is detected.

On the other hand, in a case where the full amount of the cash voucher has been used by the settlement detected by the detection unit 42 (S58: Yes), the transmission unit 44 confirms whether or not to transmit a message to the user terminal 30 of the user B (S59). Then, in a case where the user B permits transmission of the message (S60 and S61: Yes), the transmission unit 44 requests the user terminal 30 to create a message (S62). In addition, in a case where the user B does not permit transmission of the message (S60 and S61, NO), the system 1 ends the processing.

Next, the user terminal 30 of the user B creates a message by an operation of the user B (S63) and transmits the created message to the transmission unit 44 of the cash voucher management device 10 (S64). Then, the transmission unit 44 transmits the message together with the usage history of the cash voucher to the user terminal 30 of the user A (S65).

In this way, the user A may be notified that the full amount of the cash voucher has been used up. In addition, since the message and the use history are transmitted in a case where the full amount of the cash voucher is used, the number of times of the transmission processing may be reduced as compared with the case where the message and the use history are transmitted for each settlement.

In addition, a part or all of the processing performed by the cash voucher management device 10 in the above example may be performed by the user terminal 30. For example, processing similar to the detection unit 42 and the transmission unit 44 of the cash voucher management device 10 may be performed by the user terminal 30 of the user B.

In this case, the user terminal 30 stores monetary value information transmitted in response to an instruction from the user terminal 30 of the user A, the history of monetary transactions of the cash voucher, that is, the use history of the cash voucher, in the cash voucher information 45. Then, the user terminal 30 of the user B acquires the use history of the cash voucher from the cash voucher information 45 when sending a mail to the user terminal 30 of the user A and transmits the acquired use history of the cash voucher as a body text of the mail or attached information.

In addition, the value of the cash voucher may be varied depending on a store or a facility to use. In this case, the use history of the cash voucher stored in the cash voucher information 45 includes an increase in the value of the cash voucher. In this way, the increase in the value of the cash voucher may be included in the history information of the cash voucher and the user A may be notified that the user B is using the cash voucher more effectively.

For example, in a case where it is predetermined that the value of the cash voucher is doubled at a furniture store C, in the purchase use history of the record of history No. “4” in FIG. 2, “cash voucher ¥12,500 is used and a baby bed is purchased for ¥25,000 at the furniture store C (benefit of the increased value of the cash voucher: ¥12,500)” is registered. In addition, in this case, the balance will be ¥14,000.

In addition, the constituent elements of each of the devices illustrated in the drawings are functionally conceptual and do not necessarily have to be physically configured as illustrated. That is, the specific state of distribution or integration of each device is not limited to that illustrated in the drawings, and all or a part thereof may be configured by being functionally or physically distributed or integrated into arbitrary units according to various workloads and usage situations. For example, the processing units of the purchase unit 40, the transfer unit 41, the detection unit 42, the payment unit 43, and the transmission unit 44 of the cash voucher management device 10 may be integrated or divided appropriately. In addition, all or arbitrary part of each processing function performed in each processing unit may be realized by a CPU and a program analyzed and executed by the CPU or may be realized as hardware by a wired logic.

Information Transmission Program

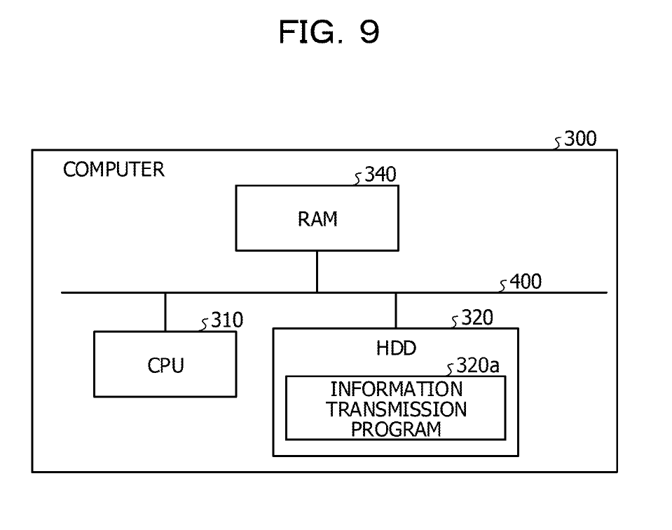

In addition, the various kinds of processing described in the above examples may also be realized by executing a prepared program on a computer system such as a personal computer or a workstation. Therefore, in the following, an example of a computer system that executes a program having the same function as the above embodiment will be described. FIG. 9 is a diagram illustrating a computer that executes an information transmission program.

As illustrated in FIG. 9, the computer 300 includes a CPU 310, a hard disk drive (HDD) 320, and a random-access memory (RAM) 340. The units 310 to 340 are connected via a bus 400.

In the HDD 320, an information transmission program 320a that serves the same function as each processing unit of the above examples is stored in advance. For example, the information transmission program 320a that serves the same functions as the detection unit 42 and the transmission unit 44 of the cash voucher management device 10 of the above examples stored. The information transmission program 320a may be appropriately separated.

In addition, the HDD 320 stores various data. For example, the HDD 320 stores an OS and various data.

Then, the CPU 310 reads the information transmission program 320a from the HDD 320 and executes the program, thereby executing operations similar to those of the detection unit 42 and the transmission unit 44 of the cash voucher management device 10 of the examples. That is, the information transmission program 320a executes the same operations as the detection unit 42 and the transmission unit 44 of the cash voucher management device 10 of the examples.

It is optional to store the information transmission program 320a in the HDD 320 from the beginning. For example, the program is stored in a “portable physical medium” such as a flexible disk (FD), a compact disk read-only memory (CD-ROM), a digital versatile disk (DVD), a magneto-optical disk, an IC card inserted into the computer 300. Then, the computer 300 may read and execute the program therefrom.

Furthermore, the program is stored in “another computer (or server)” or the like connected to the computer 300 via a public line, the Internet, a LAN, a WAN, or the like. Then, the computer 300 may read and execute the program therefrom.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information transmission method comprising:
detecting, by a computer, that at least part of a cash voucher associated with electronic information is used;
identifying a first user who sets a right of the cash voucher associated with the electronic information to a second user;
acquiring, when detecting creation or transmission of a message addressed to a first address used by the first user from a second address used by the second user, a use history of the cash voucher associated with the electronic information; and
transmitting the acquired use history together with the message.

2. The information transmission method according to claim 1,
wherein the detecting creation or transmission of the message includes a case of detecting, in a confirmation screen which asks whether or not to transmit a message addressed to the first address and is displayed on a screen of a terminal of the second user, an input indicating that the message is to be transmitted from the terminal.

3. The information transmission method according to claim 1,
wherein the use history is a use statement including a used amount of the cash voucher and information on products which are purchased by the cash voucher or names or a picture of the products.

4. The information transmission method according to claim 1,
wherein the detecting that at least part of the cash voucher is used includes detecting that the cash voucher associated with the electronic information is used for the first time or a full amount of the cash voucher is used.

5. The information transmission method according to claim 1,
wherein the transmitting includes adding, when receiving a signal indicating that the use history is allowed to be added from a terminal used by the second user, the use history together to the message and transmitting the message.

6. The information transmission method according to claim 1,
wherein the transmitting includes displaying, on a screen of a terminal used by the first user, an operation screen that receives an operation of increasing an amount of the cash voucher associated with the electronic information, together with the message and the use history.

7. The information transmission method according to claim 1, comprising:
receiving a history of monetary transactions based on monetary value information including the use history;
storing the history in a storage;
acquiring, when sending a mail to a terminal of the first user, the history from the storage; and
transmitting the history to the terminal of the first user as a body text of the mail or attached information.

8. The information transmission method according to claim 7,
wherein the monetary value information includes a monetary value that varies depending on a store or a facility to use, and
the history of the monetary transactions includes information indicating an increase in the monetary value.

9. A non-transitory computer-readable recording medium storing an information transmission program which causes a computer to execute a process, the process comprising:
detecting that at least part of a cash voucher associated with electronic information is used;
identifying a first user who sets a right of the cash voucher associated with the electronic information to a second user;
acquiring, when detecting creation or transmission of a message addressed to a first address used by the first user from a second address used by the second user, a use history of the cash voucher associated with the electronic information; and
transmitting the acquired use history together with the message.

10. The non-transitory computer-readable recording medium according to claim 9,
wherein the detecting creation or transmission of the message includes a case of detecting, in a confirmation screen which asks whether or not to transmit a message addressed to the first address and is displayed on a screen of a terminal of the second user, an input indicating that the message is to be transmitted from the terminal.

11. The non-transitory computer-readable recording medium according to claim 9,
wherein the use history is a use statement including a used amount of the cash voucher and information on products which are purchased by the cash voucher or names or a picture of the products.

12. The non-transitory computer-readable recording medium according to claim 9,
wherein the detecting that at least part of the cash voucher is used includes detecting that the cash voucher associated with the electronic information is used for the first time or a full amount of the cash voucher is used.

13. The non-transitory computer-readable recording medium according to claim 9,
wherein the transmitting includes adding, when receiving a signal indicating that the use history is allowed to be added from a terminal used by the second user, the use history together to the message and transmitting the message.

14. The non-transitory computer-readable recording medium according to claim 9,
wherein the transmitting includes displaying, on a screen of a terminal used by the first user, an operation screen that receives an operation of increasing an amount of the cash voucher associated with the electronic information, together with the message and the use history.

15. The non-transitory computer-readable recording medium according to claim 9, comprising:
receiving a history of monetary transactions based on monetary value information including the use history;
storing the history in a storage;
acquiring, when sending a mail to a terminal of the first user, the history from the storage; and
transmitting the history to the terminal of the first user as a body text of the mail or attached information.

16. The non-transitory computer-readable recording medium according to claim 15,
wherein the monetary value information includes a monetary value that varies depending on a store or a facility to use, and
the history of the monetary transactions includes information indicating an increase in the monetary value.

17. An information processing apparatus comprising:
a memory; and
a processor coupled to the memory and configured to:
detect that at least part of a cash voucher associated with electronic information is used;
identify a first user who sets a right of the cash voucher associated with the electronic information to a second user;
acquire, when detecting creation or transmission of a message addressed to a first address used by the first user from a second address used by the second user, a use history of the cash voucher associated with the electronic information; and
transmit the acquired use history together with the message.

18. The information processing apparatus according to claim 17,
wherein the detecting creation or transmission of the message includes a case of detecting, in a confirmation screen which asks whether or not to transmit a message addressed to the first address and is displayed on a screen of a terminal of the second user, an input indicating that the message is to be transmitted from the terminal.

19. The information processing apparatus according to claim 17,
wherein the use history is a use statement including a used amount of the cash voucher and information on products which are purchased by the cash voucher or names or a picture of the products.

20. The information processing apparatus according to claim 17,
wherein the detecting that at least part of the cash voucher is used includes detecting that the cash voucher associated with the electronic information is used for the first time or a full amount of the cash voucher is used.
